(19) United States
(12) Patent Application Publication
(10) Pub. No.: US 2008/0024445 A1
(43) Pub. Date: Jan. 31, 2008

(54) MOUSE DEVICE

(75) Inventor: Zheng-Heng Sun, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,731

(22) Filed: Sep. 15, 2006

(30) Foreign Application Priority Data
Jul. 26, 2006 (CN) 200620017234.8

(51) Int. Cl. G09G 5/08

(52) U.S. Cl. 345/163

(57) ABSTRACT

A mouse device for a computer includes a shell; and a magnetic member fixed to the shell for holding the mouse to another object made of metal. When the mouse device is unused, it can be held on the object made of metal. Thus, there is more space on a desk to place other things.

### 1. FIELD OF THE INVENTION

The present invention relates to computer input devices, and more particularly to a computer mouse device for controlling cursors on computer displays.

### 2. DESCRIPTION OF RELATED ART

The use of pointers on graphical user interfaces (GUIs) presented on a computer display device for interacting with application software is well-known. Essentially all Windows based or McIntosh based software utilizes such control. Accordingly, apparatus for moving the pointer on a computer screen also are well known to computer users. Probably the most common pointer control device is the well-known computer mouse device.

A computer mouse device comprises a shell shaped to fit conveniently and comfortably in the palm of the hand of the user while it rests on a flat, horizontal surface. Two or more buttons are on a top surface of the shell. Protruding from a bottom of the shell typically is a track ball or other mechanism, which is responsive to the user moving the mouse device on top of the horizontal supporting surface.

However, when the user does not use the mouse device, the mouse device is usually left on the supporting surface using up space.

What is desired, therefore, is a mouse device which provides facilities for storing the mouse device when not in use.

### SUMMARY OF THE INVENTION

In one preferred embodiment, a mouse device for a computer includes a shell; and a magnetic member fixed to the shell for holding the mouse to another object made of metal.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded isometric view of a mouse device, in accordance with a preferred embodiment of the present invention;

FIG. 2 is an assembled view of FIG. 1; and

FIG. 3 is a partly cut away side view of the mouse device of FIG. 1.

### DETAILED DESCRIPTION OF THE INVENTION

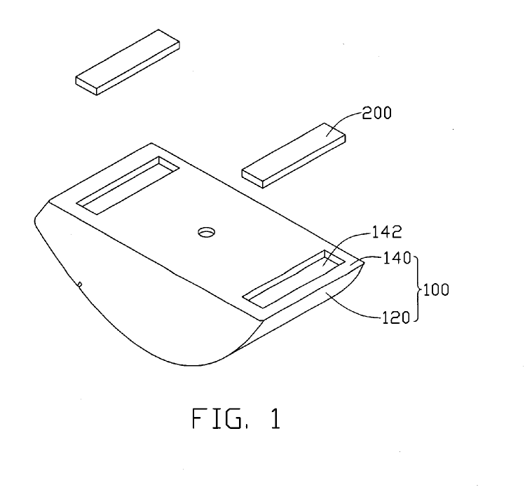

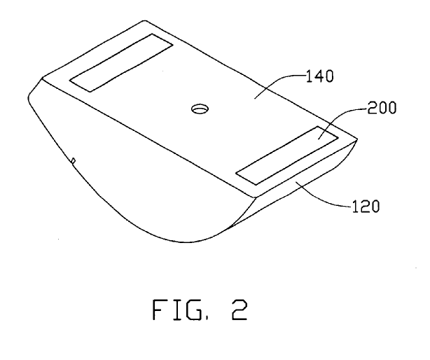

As shown in FIG. 1 to FIG. 3, in a preferred embodiment of the present invention, a mouse device used for computers includes a shell 100 and a magnetic member fixed to the shell 100. In the embodiment, two magnets 200 are used as the magnetic device. The magnets 200 may be permanent magnets or electromagnets or otherwise.

The shell 100 includes an upper portion 120 and a lower portion 140. Two grooves 142 are defined in a bottom of the lower portion 140 corresponding to the two magnets 200. The two magnets 200 are fixed in the corresponding grooves 142 by known fixing means such as glue. When the magnets 200 are fixed in the grooves 142, exposed surfaces of the magnets 200 and the bottom of the lower portion 140 are in a same plane.

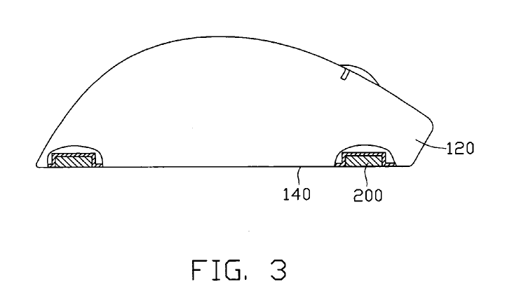

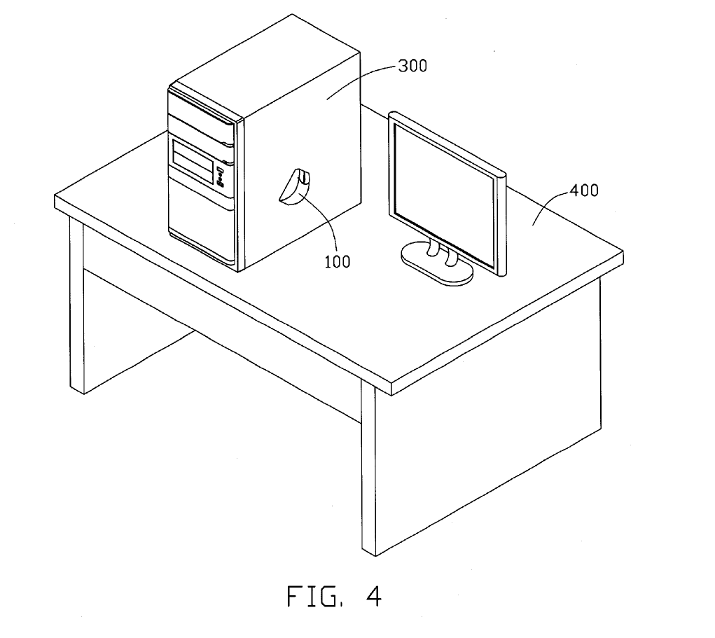

Additionally, the magnetic member can employ three or more magnets, or even only one magnet. The magnets 200 can be rectangular, round, ellipsoid, and so on. When the magnets 200 are fixed in the grooves 142, the magnets 200 can also be concave in the grooves 142, and a thin cover may be attached to cover each of the grooves 142. Alternatively, the magnets 200 can be fixed within the shell 100, as shown in FIG. 3.

Attractive force of the magnets 200 should be strong enough such that the mouse device will be held to some object made of metal. Experimentally, it was found that relatively weak magnets would not interfere with circuits of the mouse yet still cling to metal surfaces.

When the mouse device is unused, it can be conveniently stored by being placed against a metal surface such as the metal of a chassis of the computer, or a whiteboard near a user's desk. Thus, there is more space on the desk to place other things. For example shown in FIG. 4, the magnets 200 are attached to the shell 100 configured for holding the mouse device away from a supporting surface 400 to another object 300 made of metal when the mouse device is unused.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A mouse device for a computer comprising:
a mouse shell, wherein the mouse shell comprises an upper portion and a lower portion; and
a magnetic member fixed to the shell, the magnetic member holding the mouse to another object made of metal;
wherein a groove is defined in a bottom of the lower portion according to the magnetic member and the magnetic member is fixed in the groove.

2. The mouse device as claimed in claim 1, wherein the magnetic member is a permanent magnet.

3. The mouse device as claimed in claim 1, wherein a thin cover is attached to cover each of the grooves.

4. The mouse device as claimed in claim 2, wherein the permanent magnet is rectangular and the groove has a shape fitting to the permanent magnet.

5. A mouse device for a computer which sits on a supporting surface, the mouse device comprising:
a mouse shell comprising a lower portion configured for sitting on the supporting face when the mouse device is in use; and
a magnetic member attached to the shell configured for holding the mouse device away from the supporting surface to another object made of metal when the mouse device is unused.

6. The mouse device as claimed in claim 5, wherein a groove is defined in a bottom surface of the lower portion and the magnetic member is fixed in the groove and coplanar with the bottom surface.

7. The mouse device as claimed in claim 6, wherein the magnetic member is adhered in the groove by glue.

8. The mouse device as claimed in claim 5, wherein the magnetic member is located within the shell.

9. The mouse device as claimed in claim 5, wherein said another object is an enclosure of the computer.
